(19) United States
(12) Patent Application Publication
(10) Pub. No.: US 2025/0216665 A1
(43) Pub. Date: Jul. 3, 2025

(54) MICROSCOPY ASSEMBLIES

(71) Applicant: IDEXX Laboratories, Inc., Westbrook, ME (US)

(72) Inventors: Michael R. Moon, Scarborough, ME (US); Mark Raymond Dumont, Scarborough, ME (US); Philip N. Harju, Bridgton, ME (US); John H. McGibbon, Old Orchard Beach, ME (US); Alton Lawler Russo, Gorham, ME (US); Stephan Hersey, Scarborough, ME (US); Jason Harris Karp, Portland, ME (US)

(73) Assignee: IDEXX Laboratories, Inc., Westrbrok, ME (US)

(21) Appl. No.: 18/999,373

(22) Filed: Dec. 23, 2024

Related U.S. Application Data
(60) Provisional application No. 63/614,972, filed on Dec. 27, 2023.

(51) Int. Cl. G02B 21/36; G02B 21/18

(52) U.S. Cl. CPC G02B 21/361; G02B 21/18; G02B 21/362

(57) ABSTRACT

A microscopy assembly may comprise an objective lens defining an imaging path axis, one or more light sources, and a microscopy body, wherein the microscopy body defines an objective optical pathway having an objective optical axis, the monolithic microscopy body defines a light source optical pathway having a light source optical axis, the light source optical axis is transverse to the objective optical axis, the objective lens is optically coupled to the objective optical pathway, and each light source of the one or more light sources is optically coupled to the light source pathway.

### CROSS-REFERENCE TO RELATED APPLICATION

This application claims the benefit of co-pending U.S. Provisional Patent Application Ser. No. 63/614,972, filed Dec. 27, 2023, for “Microscopy Assemblies,” which is hereby incorporated by reference in its entirety including the drawings.

### BACKGROUND

### Field

The present disclosure generally relates to microscopy assemblies, and more specifically, to microscopy assemblies having any, some, or all of a monolithic microscopy, one or more modular inserts, a distance sensor, and/or a motor.

### Technical Background

Conventional microscopy assemblies may often include microscopy bodies having several sub-components, and so such conventional microscopy bodies (and, thereby, associated conventional microscopy assemblies) may be complex and time-consuming to assemble and disassemble. Moreover, the tolerance stackup of the multiple components can result in degraded performance of conventional microscopy assemblies. Accordingly, a need may exist for microscopy bodies with fewer components.

Inserting, removing, mounting, and aligning optical devices (for example, lenses and/or mirrors) in conventional microscopy assemblies may be complex and time consuming. Further, mounting an optical device within a conventional microscopy assembly may require anodization and/or complex machining operations to, for example, provide stray light reduction and/or light blocking for the optical device and/or optical signals propagating through such optical devices. Accordingly, a need exists for mechanisms for inserting, mounting, and/or aligning optical devices within a microscopy assembly that provides stray light reduction and/or light block without requiring anodization and/or complex machining operations and/or such mechanisms that provide reduced complexity and time in insertion, removal, mounting, and alignment of such optical devices.

Conventional microscopy assemblies may utilize conventional distance sensors which require reference inputs to determine relative positions of optical devices of such conventional microscopy assemblies. Inputting such reference inputs may increase a time necessary for a user to align the optical devices of such conventional microscopy assemblies. Further, conventional distance sensors may require re-input of such reference inputs if power to the distance sensors is halted or interrupted. Accordingly, a need exists for a distance sensor for a microscopy assembly that does not require reference inputs and/or may continue operation even if power is halted or interrupted thereto.

Movement of optical devices of conventional microscopy assemblies relative to one another may be time-consuming and may have high degrees of error due to mechanical positioning errors (for example, backlash). Accordingly, a need exists for mechanisms for movement of optical devices of microscopy assemblies relative to one another that reduce a time required for such movement and that reduce mechanical positioning errors.

### SUMMARY

In an embodiment, a microscopy assembly includes: an objective lens defining an imaging path axis; one or more light sources; and a monolithic microscopy body, wherein: the monolithic microscopy body defines an objective optical pathway having an objective optical axis, the monolithic microscopy body defines a light source optical pathway having a light source optical axis, the light source optical axis is transverse to the objective optical axis, the objective lens is optically coupled to the objective optical pathway, each light source of the one or more light sources is optically coupled to the light source pathway, and the imaging path axis and the objective optical axis comprise a deviation of less than or equal to 0.2 degrees.

In an embodiment, a microscopy assembly includes: an objective lens; one or more light sources; a microscopy body defining: an objective optical pathway defining an objective optical axis, a light source optical pathway defining a light source optical axis transverse to the objective optical axis, and a first optical device cavity; a modular insert engaged with the device cavity; and a mirror engaged with the modular insert and positioned within at least one of the objective optical pathway and the light source optical pathway, wherein: the objective lens is optically coupled to the objective optical pathway, and the at least one of the one or more light sources is optically coupled to the light source optical pathway.

In an embodiment, a microscopy assembly includes: an objective lens; one or more light sources; a microscopy body movably coupled to the objective lens, the microscopy body defining an objective optical pathway and a light source optical pathway; and a distance sensor assembly coupled to the objective lens, wherein: the objective lens is optically coupled to the objective optical pathway, at least one of the one or more light sources is optically coupled to the light source optical pathway, and the distance sensor assembly directly detects a detected distance indicative of a position of the microscopy body relative to the objective lens.

In an embodiment, a microscopy assembly includes: an objective lens; one or more light sources; a microscopy body defining an objective optical pathway and a light source optical pathway; and a motor coupled to the objective lens and threadedly engaged with the microscopy body, wherein: the objective lens is optically coupled to the light source optical pathway, and the motor moves the objective lens relative to the microscopy body.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a microscopy assembly, according to one or more embodiments shown and described herein;

FIG. 2 schematically depicts a monolithic microscopy body of the microscopy assembly of FIG. 1, according to one or more embodiments shown and described herein;

FIG. 3A schematically depicts an exploded view of an assembly including the microscopy body of FIG. 2, a crossed roller bearing, and a sensor mounting bracket, according to one or more embodiments shown and described herein;

FIG. 3B schematically depicts the microscopy body of FIG. 2 assembled with the roller bearing and the sensor mounting bracket of FIG. 3A in addition to a lens mounting bracket, according to one or more embodiments shown and described herein;

FIG. 4 schematically depicts the microscopy body, roller bearing, and mounting brackets of FIG. 3B assembled with a cartridge, stage, and brightfield light source, according to one or more embodiments shown and described herein;

FIG. 5A depicts an external view of a light source assembly attached to a microscopy body, according to one or more embodiments shown and described herein;

FIG. 5B schematically depicts the light source assembly of FIG. 5A, according to one or more embodiments shown and described herein; and

FIG. 5C depicts a perspective view of the light source assembly of FIG. 5A, according to one or more embodiments shown and described herein.

### DETAILED DESCRIPTION

The present disclosure is related to microscopy assemblies, and, particularly, to microscopy assemblies having any, some, or all of a monolithic microscopy body, one or more modular inserts, a distance sensor, and/or a motor. In embodiments, microscopy assemblies described herein include microscopy assemblies having a monolithic microscopy body. In embodiments, the microscopy assemblies described herein include microscopy assemblies having one or more modular inserts. In embodiments, the microscopy assemblies described herein include microscopy assemblies having a distance sensor. In embodiments, the microscopy assemblies described herein include microscopy assemblies having a motor. In embodiments, the microscopy assemblies described herein include microscopy assemblies having a monolithic microscopy body and one or more modular inserts. In embodiments, the microscopy assemblies described herein include microscopy assemblies having a monolithic microscopy body and a distance sensor. In embodiments, the microscopy assemblies described herein include microscopy assemblies having a monolithic microscopy body and a motor. In embodiments, the microscopy assemblies described herein include microscopy assemblies having one or more modular inserts and a distance sensor. In embodiments, the microscopy assemblies described herein include microscopy assemblies having one or more modular inserts and a motor. In embodiments, the microscopy assemblies described herein include microscopy assemblies having a distance sensor and a motor. In embodiments, the microscopy assemblies described herein include microscopy assemblies having a monolithic microscopy body, one or more modular inserts, and a distance sensor. In embodiments, the microscopy assemblies described herein include microscopy assemblies having a monolithic microscopy body, one or more modular inserts, and a motor. In embodiments, the microscopy assemblies described herein include microscopy assemblies having one or more modular inserts, a distance sensor, and a motor. In embodiments, the microscopy assemblies described herein include microscopy assemblies having a monolithic microscopy body, one or more modular inserts, a distance sensor, and a motor.

An advantage of microscopy assemblies described herein is that, in embodiments, microscopy assemblies described herein include monolithic microscopy bodies. In embodiments, optical components (for example, lenses, mirrors, and/or light sources) are mounted to monolithic microscopy bodies described herein such that parallelism, perpendicularity, and/or concentricity of a plane of a sample being imaged by an associated microscopy assembly of the monolithic microscopy body falls within a depth of field of the microscopy assembly without requiring leveling adjustments of any, some, or all of the optical components. By contrast, conventional, non-monolithic microscopy bodies may have multiple assembled components that require such leveling adjustments. Further, in embodiments, monolithic microscopy bodies described herein may, advantageously, reduce and/or minimize a number of components of associated microscopy assemblies (when compared to, for example, conventional microscopy assemblies). In embodiments, advantages of monolithic microscopy bodies described herein may also include a reduced assembly time of associated microscopy assemblies, by, for example, removing a need for assembly of components of a non-monolithic microscopy body. In embodiments, monolithic microscopy bodies described herein may also, advantageously, act as a common datum structure for defining one or more optical axes of optical devices of such associated monolithic microscopy assemblies, such as, for example, any, some, or all of an imaging path axis, an objective optical axis, a light source axis, an aligned light source axis, and/or a transverse light source axis. By contrast, conventional, non-monolithic microscopy bodies may not provide a common datum structure due to movements of individual components thereof. Further, in embodiments, monolithic microscopy bodies described herein may, advantageously, reduce a time necessary for alignment of optical elements of associated microscopy assemblies due to, for example, such common datum structures and/or a reduction of components of monolithic microscopy bodies described herein when compared to conventional, non-monolithic microscopy bodies.

An advantage of microscopy assemblies described herein is that, in embodiments, microscopy assemblies described herein include one or more modular inserts. In embodiments, modular inserts described herein may, advantageously, provide a mounting scheme for optical devices of associated microscopy assemblies (for example, lenses, mirrors, and/or light sources) that may provide stray light reduction and/or light blocking for such optical devices without, for example, a need for anodization and/or complex machining operations. In embodiments, modular inserts described herein may also, advantageously, provide mounting mechanisms that reduce a number of attachment mechanisms (for example, threaded retainers, clips, and/or adhesives) for mounting optical devices of associated microscopy assemblies (for example, lenses, mirrors, and/or light sources), when compared to conventional microscopy assemblies lacking modular inserts.

An advantage of microscopy assemblies described herein is that, in embodiments, microscopy assemblies described herein include distance sensors that directly measure distance. In embodiments, distance sensors described herein may, advantageously, eliminate a need for a reference input when determining relative positions of optical devices of associated microscopy assemblies (for example, lenses, mirrors, and/or light sources) by, for example, utilizing inductance sensors and metal targets. Accordingly, in embodiments, microscopy assemblies having distance sensors described herein may not require positional feedback devices (for example, optical beam sensors, rotary shaft encoders, and/or linear encoder strips) which may be necessary for determining relative positions of optical devices of conventional microscopy assemblies. In embodiments, distance sensors described herein may, advantageously, maintain a feedback signal even if electronic power to the distance sensor is disconnected or interrupted by, for example, utilizing inductance coils in such distance sensors described herein.

An advantage of microscopy assemblies described herein is that, in embodiments, microscopy assemblies described herein include motors engaged with threaded members. In embodiments, motors described herein may provide repeatable positioning by reducing magnitudes of mechanical positioning errors (for example, backlash) commonly associated with conventional motors of conventional microscopy assemblies.

An advantage of microscopy assemblies described herein is that, in embodiments, microscopy assemblies described herein include light source assemblies having self-alignment mechanisms. Conventional microscopy assemblies may utilize mechanical alignment fixtures (for example, actuators, springs, and/or adjustment screws) to align light sources of conventional light source assemblies of such conventional microscopy assemblies, and conventional microscopy assemblies may further require post-alignment securing of light sources of such light source assemblies with, for example, fasteners or adhesives. However, in embodiments, light source assemblies described herein may hold a lens and/or a light source of such light source assemblies concentric by referencing features of the light source directly, thereby, in embodiments, reducing or eliminating active alignment and/or adjustment of such light source assemblies described herein to concentrically position light sources associated therewith. In embodiments, light source assemblies described herein may thereby reduce or eliminate a time or number of steps necessary to align light sources of such light source assemblies when compared to conventional light source assemblies. Further, in embodiments, light source assemblies described herein may ease assembly and/or disassembly of such light source assemblies and/or associated microscopy assemblies by eliminating a need for removing an adhesive from such light source assemblies and/or other destructive steps. Further, in embodiments, light source assemblies described herein may reduce a total number of parts of such light source assemblies and/or associated microscopy assemblies by reducing or eliminating a need for mechanical alignment fixtures (for example, actuators, springs, and/or adjustment screws).

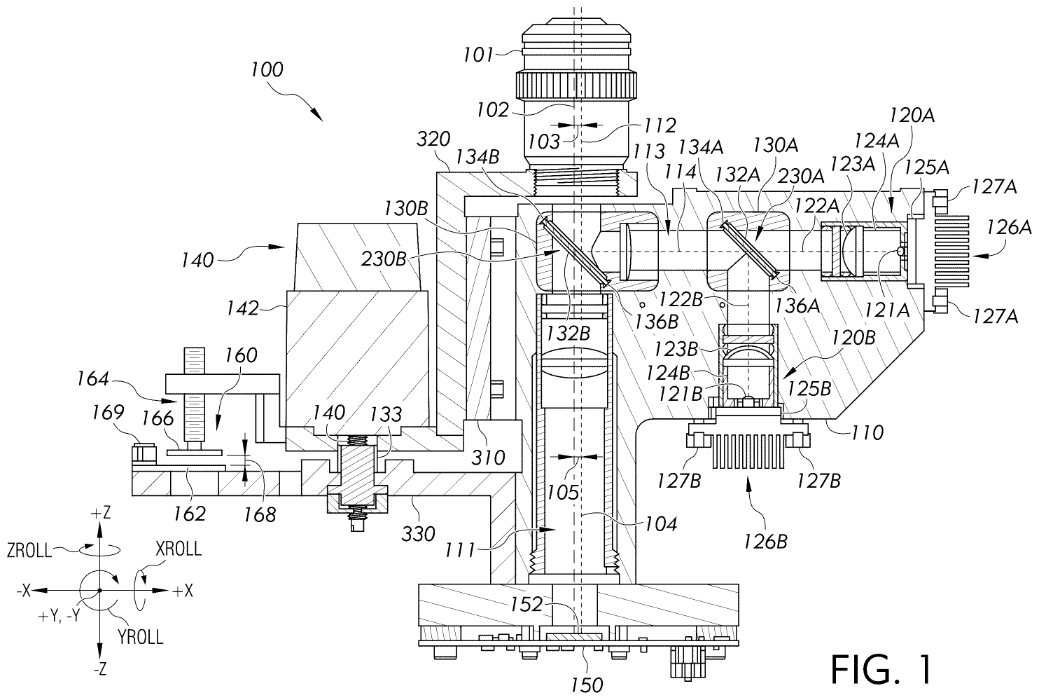

Turning now to the drawings, FIG. 1 depicts a microscopy assembly 100. In embodiments, the microscopy assembly includes an objective lens 101, a microscopy body 110, and light source assemblies 120A, 120B. In embodiments, the microscopy body 110 defines an objective optical pathway 111 and a light source optical pathway 113. In the embodiment of FIG. 1, the microscopy assembly 100 includes two light source assemblies 120A, 120B. However, in other embodiments, the microscopy assembly 100 may include only one light source assembly, and, in other embodiments, the microscopy assembly 100 may include any plurality of light source assemblies, such as three light source assemblies, four light source assemblies, or even five or more light source assemblies.

In embodiments, the objective optical pathway 111 may be a cavity defined by the microscopy body 110 which, for example, provides an optical path for optical signals (for example, visible light, ultraviolet light, blue light, white light, fluorescence light, infrared light, other electromagnetic waves, and/or any combination thereof) propagating between the objective lens 101 and an imaging sensor 152. In the embodiment depicted in FIG. 1, the imaging sensor 152 is positioned upon a base surface 150 of the microscopy assembly 100. In embodiments, the objective lens 101 defines an imaging path axis 102 which, in embodiments, extends from a center of the objective lens 101, through the objective optical pathway 111, and to the imaging sensor 152. Accordingly, the objective lens 101 is optically coupled to the imaging sensor 152 through the optical pathway 111.

The term “optically coupled,” as used herein with reference to one or more first optical devices (for example, the objective lens 101) and one or more second optical devices (for example, the imaging sensor 152) are positioned, oriented, and/or designed such that optical signals (for example, for example, visible light, ultraviolet light, blue light, white light, fluorescence light, infrared light, other electromagnetic waves, and/or any combination thereof) may propagate between the one or more first optical devices and the one or more second optical devices. Further, devices and/or components may be said to be “optically coupled” when each device and/or component is within the same optical path of an optical signal transmitted between, through, to, and/or from the devices and/or components. Accordingly, the term “optical path” when used herein with respect to an optical signal is the path of the optical signal transmitted by, between, and/or through one or more devices and/or components. However, the term “optical pathway” when used herein to define a cavity includes a cavity in which light may propagate therein, for example, from one end of the cavity to another end of the cavity.

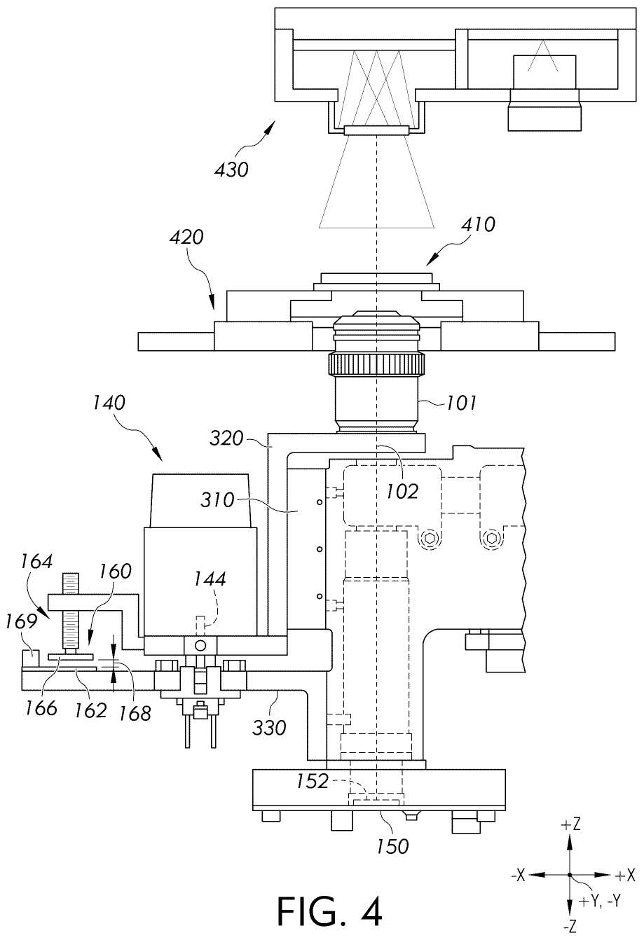

Accordingly, by being optically coupled, the imaging sensor 152 may capture images of a sample cartridge (described elsewhere herein and depicted in FIG. 4) positioned opposite the objective lens 101 from the imaging sensor 152 by detecting optical signals propagating through the sample cartridge and the objective lens 101 along and/or parallel to the imaging path axis 102. In embodiments, the objective optical pathway 111 may define an objective optical axis 104 along, for example, a center of the objective optical pathway 111. In embodiments, the objective optical axis 104 and the imaging path axis 102 may define, within the objective optical pathway 111, the same or substantially the same axis. However, in some embodiments, the objective optical axis 104 and the imaging path axis 102 may, instead, define a deviation 105 therebetween. In embodiments (such as, for example, embodiments wherein the imaging path axis 102 and the objective optical axis 104 are parallel or substantially parallel), the deviation 105 may be a distance, for example, in the x-direction and/or in the y-direction of the coordinate planes of FIG. 1, between the axes 102, 104. Accordingly, in certain such embodiments, the deviation 105 may have a magnitude less than or equal to 0.33 millimeters (“mm”). In embodiments (such as, for example, embodiments wherein either or both of the imaging path axis 102 and/or the objective optical axis 104 are not parallel to the z-axis of the coordinate planes of FIG. 1), the deviation 105 may be an angle formed by the axes 102, 104 (for example, in any, some, or all of the xᵣₒₗₗ, yᵣₒₗₗ, and/or zᵣₒₗₗ coordinates of FIG. 1). Accordingly, in certain such embodiments, the deviation 105 may have a magnitude less than or equal to 0.2 degrees. In embodiments, the deviation 105 may comprise both an angle formed by the axes 102, 104 and a distance between the axes 102, 104.

In embodiments, the objective lens 101 may define an objective lens axis 112 along, for example, a center of the objective lens 101. In embodiments, the objective lens axis 112 and the imaging path axis 102 may define, within the objective optical pathway 111, the same or substantially the same axis. However, in some embodiments, the objective optical axis 104 and the lens axis 112 may, instead, define a deviation 103 therebetween. In embodiments (such as, for example, embodiments wherein the imaging path axis 102 and the lens axis 112 are parallel or substantially parallel), the deviation 103 may be a distance, for example, in the x-direction and/or in the y-direction of the coordinate planes of FIG. 1, between the axes 102, 112. Accordingly, in certain such embodiments, the deviation 103 may have a magnitude less than or equal to 0.33 mm. In embodiments (such as, for example, embodiments wherein either or both of the imaging path axis 102 and/or the lens axis 112 are not parallel to the z-axis of the coordinate planes of FIG. 1), the deviation 103 may be an angle formed by the axes 102, 112 (for example, in any, some, or all of the xᵣₒₗₗ, yᵣₒₗₗ, and/or zᵣₒₗₗ coordinates of FIG. 1). Accordingly, in certain such embodiments, the deviation 103 may have a magnitude less than or equal to 0.2 degrees. In embodiments, the deviation 103 may comprise both an angle formed by the axes 102, 112 and a distance between the axes 102, 112.

In embodiments, the light source optical pathway 113 is a cavity defined by the microscopy body 110. The cavity of the light source optical pathway 113 provides an optical path for optical signals propagating from either or both of the light source assemblies 120A, 120B. In embodiments, the light source optical pathway 113 defines a light source optical axis 114 along, for example, a center of the light source optical pathway 113. In embodiments, the light source optical axis 114 is transverse to the objective optical axis 104. The light source optical axis 114, in embodiments, may be transverse to the imaging path axis 102.

The term “transverse,” as used herein with reference to, for example, a first axis (for example, the objective optical axis 104) and a second axis (for example, the light source optical axis 114) includes axes which are positioned or oriented such that the axes are not parallel to each other. That is to say, the axes define a non-zero angle relative to one another, and, thereby, either intersect or would intersect if extended. It should be understood, however, that the term “transverse” as used herein is not intended to exclusively be limited to description of axes relative to each other. Rather, a first elongate component (for example, the objective optical pathway 111) may be considered to be transverse to a second longitudinal component (for example, the light source optical pathway 113) when a first vector (as parameterized in, for example, the x/z plane of FIG. 1) along a length of the first elongate component defines a non-zero angle relative to a second vector (as parameterized in, for example, the x/z plane of FIG. 1) along a length of the second elongate component.

In embodiments, the light source assemblies 120A, 120B include light sources 121A, 121B, respectively. In embodiments, either or both of the light sources 121A, 121B may be and/or include, for example, one or more light-emitting diodes (“LEDs”). In some embodiments, either or both of the light sources 121A, 121B may be any device which may emit light (for example, visible light, ultraviolet light, blue light, white light, fluorescence light, and/or infrared light) and/or other electromagnetic waves such as, for example, visible light sources, ultraviolet light sources, blue light sources, white light sources, fluorescence light sources, infrared light sources, electromagnetic wave light sources, other light sources, and/or any combination thereof. Accordingly, the light sources 121A, 121B may, in embodiments, be optically coupled to the light source pathway. In embodiments, the light sources 121A, 121B may be used by the microscopy assembly 100, for example, for fluorescence detection. In embodiments, either or both of the light sources 121A, 121B may include only one light source. In embodiments, either or both of the light sources 121A, 121B may include any plurality of light sources, such as two light sources, three light sources, or even four or more light sources. In embodiments, each of the light sources 121A, 121B may include the same or a different number of light sources.

In embodiments, the cavities defining the objective optical pathway 111 and the light source optical pathway 113 intersect, such that both of the light sources 121A, 121B are optically coupled to both the light source optical pathway 113 and the objective optical pathway 111. Accordingly, in embodiments, optical signals emitted by either or both of the light sources 121A, 121B may propagate through the light source optical pathway 113 and into the objective optical pathway 111.

Optical signals from either or both of the light sources 121A, 121B may be reflected, redirected, or otherwise modified in optical paths thereof by a first optical device 132A (for example, a mirror) positioned in a first optical device cavity 230A. In embodiments, the first optical device cavity 230A may be positioned at least partially within and/or along the light source optical pathway 113. Accordingly, in embodiments, the first optical device cavity 230A (and, thereby, the first optical device 132A positioned therein) may be positioned along and/or about the light source optical axis 114, thereby positioning the first optical device 132A along an optical path of optical signals emitted by either of both of the light sources 121A, 121B. In embodiments, the first optical device 132A may not be a mirror, and may, rather, be another optical device, such as a lens.

Optical signals from any, some, or all of the light sources 121A, 121B, a brightfield light source (for example, a brightfield light source 430, depicted in FIG. 4 and described elsewhere herein) positioned opposite the imaging sensor 152 (that is to say, on an end of the imaging path axis 102 opposite the objective lens 101 from the imaging sensor 152), and/or other light sources may be reflected, redirected, or otherwise modified in optical paths thereof by a second optical device 132B positioned in a second optical device cavity 230B. In embodiments, the second optical device cavity 230B may be positioned at least partially within and/or along the objective optical pathway 111. Accordingly, in embodiments, the second optical device cavity 230B (and, thereby, the second optical device 132B positioned therein) may intersect the objective optical axis 104, thereby positioning the second optical device 132B along an optical path of optical signals propagating between the objective lens 101 and the imaging sensor 152. Further, in embodiments, the second optical device cavity 230B may be positioned at least partially within an intersection of the objective optical pathway 111 and the light source optical pathway 113. Accordingly, in embodiments, the second optical device cavity 230B (and, thereby, the second optical device 132B positioned therein) may intersect the light source optical axis 114, thereby positioning the second optical device 132B along an optical path of optical signals emitted by either or both of the light sources 121A, 121B. In embodiments, the second optical device cavity 230B may, thereby, be positioned at least partially within both the objective optical pathway 111 and at least partially within the light source optical pathway 113. Accordingly, in embodiments, the second optical device cavity 230B (and, thereby, the second optical device 132B positioned therein) may intersect both the objective optical axis 104 and the light source optical axis 114, thereby positioning the second optical device 132B along both an optical path of optical signals emitted by either or both of the light sources 121A, 121B and an optical path of optical signals propagating between the objective lens 101 and the imaging sensor 152. In embodiments, the second optical device 132B may not be a mirror, and may, rather, be another optical device, such as a lens.

In the embodiment of FIG. 1, the microscopy assembly 100 includes two device cavities 230A, 230B. However, in other embodiments, the microscopy assembly 100 may include one device cavity or any plurality of device cavities, such as, for example three device cavities, or even four or more device cavities. In embodiments, either or both of the device cavities 230A, 230B (and, in embodiments containing three or more device cavities, any, some, or all of such device cavities) may, alternatively, be positioned at least partially within either or both of the objective optical pathway 111 and the light source optical pathway 113. Further, in embodiments, each of the device cavities 230A, 230B is depicted as only containing one optical device 132A, 132B, respectively. However, in other embodiments, either or both of the device cavities 230A, 230B may contain any plurality of mirrors, such as two mirrors or even three or more mirrors. In embodiments, either or both of the optical devices 132A, 132B (and, in embodiments containing three or more mirrors, any, some, or all of such mirrors) may be positioned within either or both of the objective optical pathway 111 and the light source optical pathway 113.

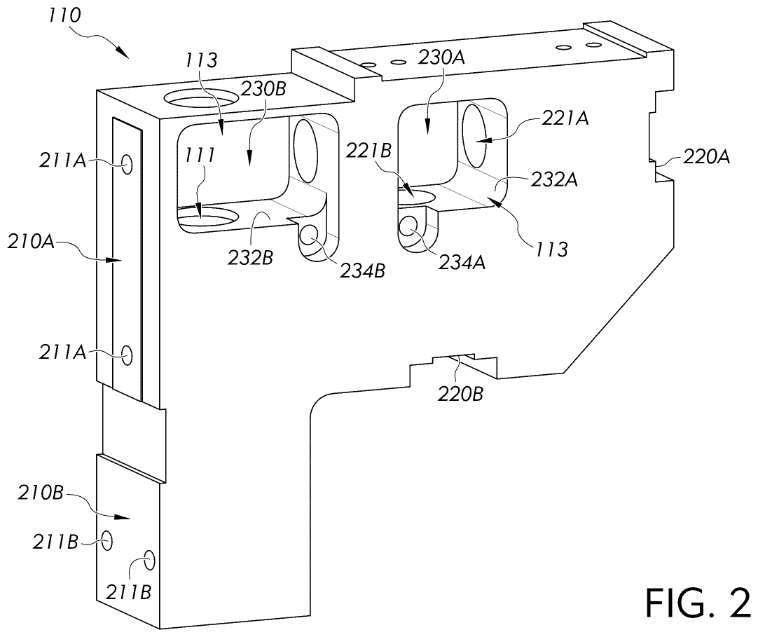

Referring now to the embodiment of FIG. 2, in embodiments, the microscopy body 110 may be a monolithic microscopy body. It should be understood that the term “monolithic” as used herein with reference to microscopy bodies refers to a microscopy body that is a single integral component. That is, monolithic microscopy bodies lack separate parts or components and, instead, comprise a single component. Accordingly, as can be seen in the depiction of FIG. 2, the microscopy body 110 is a monolithic microscopy body at least because the microscopy body 110 includes only a single, monolithically formed component. Accordingly, assembly of the microscopy body 110 may, in embodiments, not require assembly of subcomponents thereof, as, in embodiments wherein the microscopy body 110 is a monolithic microscopy body, the microscopy body 110 contains no subcomponents.

Referring still to FIG. 2, because, in embodiments, the microscopy body 110 has no subcomponents, the microscopy body 110 may not suffer or suffer a lesser degree of (when compared to conventional microscopy assemblies) tolerance stackup, as, due to being monolithic, there are no components of the microscopy body 110 connecting, coupling, or otherwise contacting one another. Accordingly, the microscopy body 110 may singularly define, for example, the objective optical axis 104, thereby reducing inaccuracies which may be otherwise generated due to, for example, multiple components causing tolerance stackup.

Referring now to FIGS. 1 and 2, in embodiments, the microscopy assembly 100 may include a first modular insert 130A. In embodiments, the first modular insert 130A may be engaged in the first optical device cavity 230A. In embodiments, the first optical device cavity 230A and the first modular insert 130A may be precision machined such that a first optical device cavity internal surface 232A of the first optical device cavity 230A is flush or substantially flush with the first modular insert 130A. Accordingly, in embodiments, a spacing between the first optical device cavity internal surface 232A and the first modular insert 130A may be less than or equal to 0.1 mm. In embodiments, a spacing between the first optical device cavity internal surface 232A and the first modular insert 130A may be less than or equal to 0.05 mm.

In embodiments, the first optical device 132A may be engaged with the first modular insert 130A. In embodiments, the first modular insert 130A may retain the first optical device 132A. In embodiments, the first modular insert 130A may define a first engagement portion 134A which retains the first optical device 132A at least partially within the first modular insert 130A. In some embodiments, the first modular insert 130A may further define a second engagement portion 136A opposite the first engagement portion 134A, the second engagement portion 136A retaining the first optical device 132A at least partially within the first modular insert 130A. In embodiments, either or both of the engagement portions 134A, 136A may be, for example, bores in the first modular insert 130A sized to retain an end of the first optical device 132A. In embodiments, either or both of the engagement portions 134A, 136A may be precision machined such that either or both of the engagement portions 134A, 136A are flush or substantially flush against the first optical device 132A, such that either or both of the engagement portions 134B, 136B tightly retain and/or align the second optical device 132B. Accordingly, in embodiments, when either or both of the engagement portions 134A, 136A are retaining the first optical device 132A, a spacing between the first optical device 132A and either or both of the engagement portions 134A, 136A may be less than or equal to 0.1 mm. In embodiments, when either or both of the engagement portions 134A, 136A are retaining the first optical device 132A, a spacing between the first optical device 132A and either or both of the engagement portions 134A, 136A may be less than or equal to 0.08 mm.

In embodiments, the microscopy assembly 100 may include a second modular insert 130B. In embodiments, the second modular insert 130B may be engaged in the second optical device cavity 230B. In embodiments, the second optical device cavity 230B and the second modular insert 130B may be precision machined such that a second optical device cavity internal surface 232B of the second optical device cavity 230B is flush or substantially flush with the second modular insert 130B. Accordingly, in embodiments, a spacing between the second optical device cavity internal surface 232B and the second modular insert 130B may be less than or equal to 0.1 mm. In embodiments, a spacing between the first optical device cavity internal surface 232A and the first modular insert 130A may be less than or equal to 0.05 mm.

In embodiments, the second optical device 132B may be engaged with the second modular insert 130B. In embodiments, the second modular insert 130B may retain the second optical device 132B. In embodiments, the second modular insert 130B may define a first engagement portion 134B which retains the second optical device 132B at least partially within the second modular insert 130B. In some embodiments, the second modular insert 130B may further define a second engagement portion 136B opposite the first engagement portion 134B, the second engagement portion 136B retaining the second optical device 132B at least partially within the second modular insert 130B. In embodiments, either or both of the engagement portions 134B, 136B may be, for example, bores in the second modular insert 130B sized to retain an end of the second optical device 132B. In embodiments, either or both of the engagement portions 134B, 136B may be precision machined such that either or both of the engagement portions 134B, 136B are flush or substantially flush against the second optical device 132B, such that either or both of the engagement portions 134B, 136B tightly retain and/or align the second optical device 132B. Accordingly, in embodiments, when either or both of the engagement portions 134B, 136B are retaining the second optical device 132B, a spacing between the second optical device 132B and either or both of the engagement portions 134B, 136B may be less than or equal to 0.1 mm. In embodiments, when either or both of the engagement portions 134A, 136A are retaining the first optical device 132A, a spacing between the first optical device 132A and either or both of the engagement portions 134A, 136A may be less than or equal to 0.08 mm.

In embodiments, either or both of the modular inserts 130A, 130B may ease alignment of optical devices retained therein (for example, the optical devices 132A, 132B, lenses, and/or other optical devices) by providing (via, for example, any, some, or all of the engagement portions 134A, 136A, 134B, 136B) either or both of precision surfaces for mounting such optical devices both within the modular inserts 130A, 130B and/or within the microscopy body 110. Accordingly, in embodiments, the modular inserts 130A, 130B may reduce a time necessary to align optical devices retained therein (for example, the optical devices 132A, 132B, lenses, and/or other optical devices) relative to any, some, or all of the microscopy body 110, the light source assemblies 120A, 120B, the objective lens 101, and/or any other components.

In embodiments, either or both of the modular inserts 130A, 130B may provide stray light reduction and/or light blocking for optical signals propagating within either or both of the optical pathways 111, 113 by, for example, the precision of the fit of either or both of the modular inserts 130A, 130B within the microscopy body 110 and/or due to a reduced number of components (and, therefore, a reduced number of engagement surfaces therebetween) of the microscopy assembly 100. Accordingly, in embodiments, either or both of the modular inserts 130A, 130B may provide a way for positioning, removing, and/or inserting either or both of the optical devices 132A, 132B and/or other optical devices, such as lenses, at least partially within either or both of the optical pathways 111, 113 without requiring anodization, complex machining operations, or other methods for providing stray light reduction and/or light blocking for the optical pathways 111, 113, the optical devices 132A, 132B, any other optical devices, such as lenses, positioned within either or both of the device cavities 230A, 230B, and/or optical signals propagating therein.

In embodiments, either or both of the modular inserts 130A, 130B may be formed from any, some, or all of a polymer (for example, a polyetherimide plastic such as ULTEM® and/or an acetal resin such as Delrin®), a metal, a ceramic, and/or another material. In embodiments, any, some, or all of the engagement portions 134A, 136A, 134B, 136B may be formed from any, some, or all of a polymer ((for example, a polyetherimide plastic such as ULTEM® and/or an acetal resin such as Delrin®)), a metal, a ceramic, and/or another material.

In embodiments, the first modular insert 130A may be retained within the first optical device cavity 230A by a fastener extending through the first modular insert 130A and into a first modular insert mounting hole 234A of the microscopy body 110. In embodiments, the first modular insert mounting hole 234A may be threaded such that, for example, the first modular insert 130A may be fastened into the first optical device cavity 230A. While the embodiment of FIG. 2 depicts only one first modular insert mounting hole 234A, other embodiments may include any plurality of modular insert mounting holes, such as two modular insert mounting holes, three modular insert mounting holes, or even four or more modular insert mounting holes. In embodiments, the first modular insert 130A may be retained within the first optical device cavity 230A by other fastening mechanisms which may, in embodiments, not require the microscopy body 110 to include the first modular insert mounting hole 234A.

In embodiments, the second modular insert 130B may be retained within the second optical device cavity 230B by a fastener extending through the second modular insert 130B and into a second modular insert mounting hole 234B of the microscopy body 110. In embodiments, the second modular insert mounting hole 234B may be threaded such that, for example, the second modular insert 130B may be fastened into the second optical device cavity 230B. While the embodiment of FIG. 2 depicts only one second modular insert mounting hole 234B, other embodiments may include any plurality of modular insert mounting holes, such as two modular insert mounting holes, three modular insert mounting holes, or even four or more modular insert mounting holes. In embodiments, the second modular insert 130B may be retained within the second optical device cavity 230B by other fastening mechanisms which may, in embodiments, not require the microscopy body 110 to include the second modular insert mounting hole 234B.

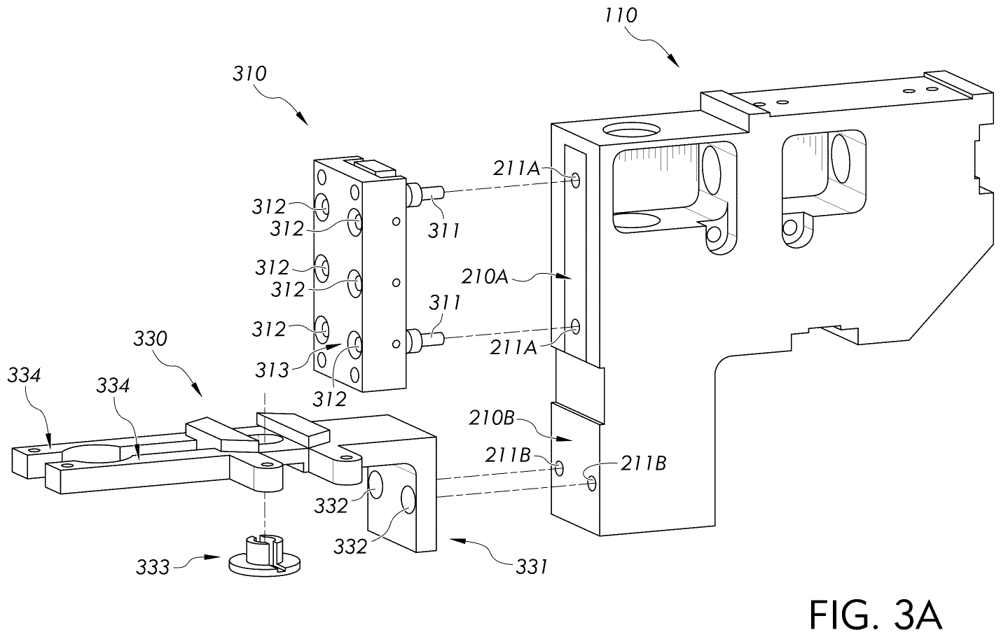

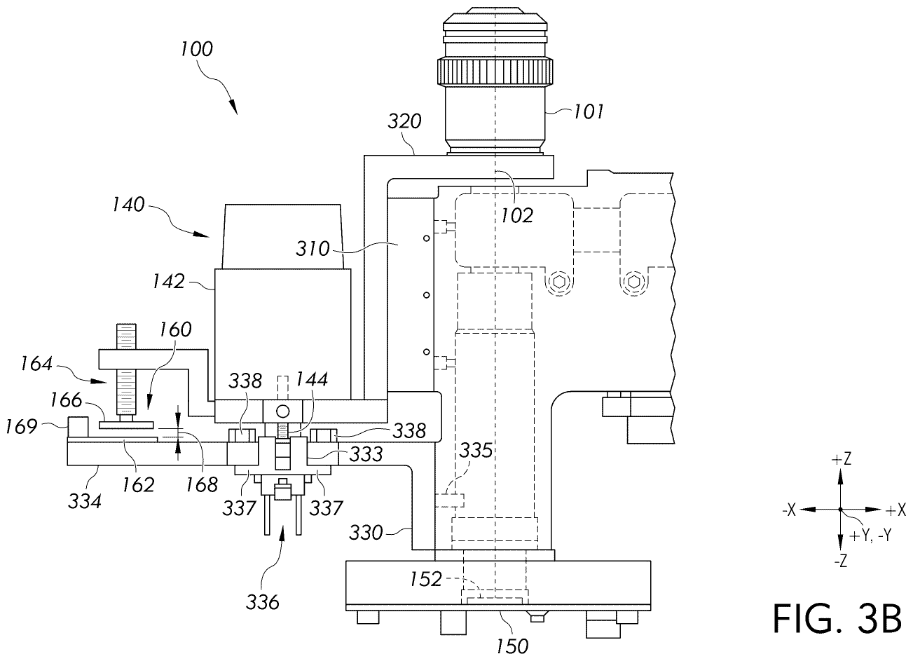

Referring again to FIG. 1, in embodiments, the microscopy assembly 100 includes a motor 140. In embodiments, the motor 140 may be a stepper motor. In embodiments, the motor 140 may be coupled to the objective lens 101 by, for example, both the objective lens 101 and the motor 140 being attached to a first mounting bracket 320. Accordingly, in embodiments, the objective lens 101 may be positioned above the microscopy body 110. In embodiments, the microscopy assembly 100 may also include a second mounting bracket 330 and, in certain such embodiments, the motor 140 may be threadedly engaged with the second mounting bracket 330. In embodiments, the second mounting bracket 330 may be a component of the microscopy body 110 and/or (for example, in embodiments wherein the microscopy body 110 is monolithically formed) the second mounting bracket 330 may be monolithically formed with the microscopy body 110. Accordingly, in embodiments, the motor 140 may be threadedly engaged with the microscopy body 110. However, in other embodiments (as described elsewhere herein and depicted in, for example, FIG. 3A) the second mounting bracket 330 may, instead, be a component of the microscopy assembly 100 attached to the microscopy body 110.

Referring now to FIGS. 1 and 3A, in embodiments, the motor 140 may include motor housing 142 and a motor shaft 144 extending outwardly from the motor housing 142. In embodiments, and as described in further detail elsewhere herein, the motor housing 142 may be positioned above the motor shaft 144 such that, for example, the motor housing 142, under the influence of gravity, exerts a downward (for example, in the −z-direction of the coordinate planes of FIG. 1) upon the motor shaft 144. In embodiments, the second mounting bracket 330 may be coupled to a motor nut 333 which defines a hole in which the motor shaft 144 is engaged. In embodiments, the motor shaft 144 and the motor nut 333 may both be threaded (such that, for example, the hole defined by the motor nut 333 is threaded), such that the motor shaft 144 is threadedly engaged with the motor nut 333. In embodiments, the motor nut 333 may be coupled to the second mounting bracket 330. However, in other embodiments (for example, embodiments wherein the second mounting bracket 330 and the microscopy body 110 are integrally formed), the microscopy body 110 may define the hole in which the motor shaft 144 is engaged.

In embodiments, the microscopy assembly 100 may include a crossed roller bearing 310 mounted to the microscopy body 110. In embodiments, the microscopy body 110 may include a first mounting bracket mounting surface 210A on a side of the microscopy body 110. Accordingly, in embodiments, the crossed roller bearing 310 may be mounted to the side of the microscopy body 110 having the first mounting bracket mounting surface 210A. In embodiments, the first mounting bracket mounting surface 210A may include one or more first mounting bracket mounting holes 211A, and, in such embodiments, the crossed roller bearing 310 may be mounted to the first mounting bracket mounting surface 210A by inserting one or more roller bearing fasteners 311 into the one or more first mounting bracket mounting holes 211A. In embodiments, any, some, or all of the roller bearing fasteners 311 and any, some, or all of the first mounting bracket mounting holes 211A may be threaded (for example, in embodiments wherein any, some, or all of the roller bearing fasteners 311 are screws), such that, in embodiments, any, some, or all of the roller bearing fasteners 311 (for example, screws) may threadedly engaged with any, some, or all of the first mounting bracket mounting holes 211A.

Referring now to FIGS. 3A-3B, in embodiments, the microscopy body 110 may include a second mounting bracket mounting surface 210B on a side of the microscopy body 110. Accordingly, in embodiments, the second mounting bracket 330 may be mounted to the side of the microscopy body 110 having the second mounting bracket mounting surface 210B. In embodiments, the second mounting bracket mounting surface 210B may include one or more second mounting bracket mounting holes 211B and the second mounting bracket 330 may include one or more second mounting bracket holes 332 extending to a second mounting bracket interior surface 331 of the second mounting bracket 330. Accordingly, in certain such embodiments, the second mounting bracket 330 may be mounted to the second mounting bracket mounting surface 210B by inserting one or more second mounting bracket fasteners 335 through the one or more second mounting bracket holes 332 and into the one or more second mounting bracket mounting holes 211B, thereby attaching the second mounting bracket 330 to the microscopy body 110 by contacting the second mounting bracket mounting surface 210B to the second mounting bracket interior surface 331. In embodiments, any, some, or all of the second mounting bracket holes 332, any, some, or all of the second mounting bracket mounting holes 211B, and any, some, or all of the second mounting bracket fasteners 335 may be threaded, such that, in embodiments, the second mounting bracket fasteners 335 (for example, screws) may threadedly engage the holes 211B, 332 to attach the second mounting bracket 330 to the microscopy body 110.

Referring still to FIGS. 3A-3B, in embodiments, the first mounting bracket 320 may be mounted to the crossed roller bearing 310. In embodiments, the objective lens 101 and the motor 140 may be coupled to the first mounting bracket 320 and, accordingly, in embodiments the microscopy body 110 may be movably coupled to the objective lens 101. In embodiments, fasteners may attach the first mounting bracket 320 to roller bearing holes 312 in a roller bearing mounting surface 313 of the crossed roller bearing 310. Accordingly, in embodiments, the crossed roller bearing 310 may enable the motor 140 to move the first mounting bracket 320 parallel to the z-axis of the coordinate planes of FIG. 3B, thereby enabling the objective lens 101 to be controllably positioned relative to the microscopy body 110.

Referring to FIG. 3B, in embodiments, the motor 140 may move the first mounting bracket 320 relative to the microscopy body 110 by rotating the motor shaft 144 within the hole defined by the motor nut 333. In embodiments wherein the motor shaft 144 and the motor nut 333 are threaded, such rotation of the motor shaft 144 may reposition threads of the motor shaft 144 relative to threads of the motor nut 333, thereby moving the motor shaft 144 (and, thereby, the first mounting bracket 320 and/or the objective lens 101) relative to the microscopy body 110 (parallel to, for example, the z-axis of the coordinate planes of FIG. 3B). In embodiments wherein the motor housing 142 is positioned above the motor shaft 144, the motor housing 142 may exert, under the force of gravity, downward force (for example, in the −z-direction of the coordinate planes of FIG. 3B) upon the motor shaft 144, thereby biasing threads of the motor shaft 144 against threads of the motor nut 333. Accordingly, in such embodiments, backlash between threads of the motor shaft 144 and threads of the motor nut 333 may be reduced, as the force exerted by the motor housing 142 upon the motor shaft 144 may reduce any spacing, in the −z direction of the coordinate planes of FIG. 3B, between the threads of the motor shaft 144 and threads of the motor nut 333.

As described herein, “backlash” is a phenomenon which occurs between two threaded components wherein threads of a first threaded component (for example, the motor shaft 144) have space to move along an axis (for example, the z-axis of the coordinate planes of FIG. 3B) relative to threads of a second threaded component (for example, the motor nut 333) to which the first threaded component is threadedly engaged without rotation of the first threaded component. Accordingly, in embodiments, the force exerted upon the motor shaft 144 by the motor housing 142 under the influence of gravity may reduce backlash by biasing threads of the motor shaft 144 downward against threads of the motor nut 333, thereby reducing a variance in a position of threads of the motor shaft 144 relative to threads of the motor nut 333.

In embodiments, the motor nut 333 may be held in place, relative to the second mounting bracket 330, by a motor nut clamp 336. In embodiments, the motor nut clamp 336 may include one or more motor nut clamp flats 337 which may, in embodiments, retain a position, relative to the z-axis of the coordinate planes of FIG. 3B, of the motor nut 333 relative to the second mounting bracket 330. In embodiments, the motor nut clamp 336 may include one or more motor nut clamp nuts 338 which may, in embodiments, retain a position, relative to the x- and y-axes of the coordinate planes of FIG. 3B, of the motor nut 333 relative to the second mounting bracket 330. Accordingly, in embodiments, a position of the motor nut 333 and, thereby, the motor 140 and, thereby, the objective lens 101 may be kept stable in positions of the same relative to the microscopy body 110, thereby, in embodiments, providing a high degree of accuracy of movement, by the motor 140, of the objective lens 101 relative to the microscopy body 110.

It should be understood that while, in the embodiments depicted in FIGS. 3A-3B, the motor 140 is coupled to the first mounting bracket 320 such that the motor 140 itself moves relative to the microscopy body 110, in other embodiments, the motor 140 may be fixedly coupled to the microscopy body 110 (for example, in embodiments wherein the motor 140 is attached to the second mounting bracket 330, rather than the first mounting bracket 320). Accordingly, in embodiments, the motor 140 may move the objective lens 101 relative to the microscopy body 110 without also moving the motor 140 relative to the microscopy body 110.

Referring now to FIGS. 1 and 4, in embodiments, the microscopy assembly 100 may further include and/or be coupled to a x- and y-stages 420, upon which a cartridge 410 is positioned, and a brightfield light source 430. In embodiments, the brightfield light source 430 may be positioned opposite the imaging sensor 152 such that, in embodiments, the brightfield light source 430 may intersect the imaging path axis 102. Accordingly, in embodiments, the brightfield light source 430 may be optically coupled the imaging sensor 152 via the objective optical pathway 111 as, in embodiments, an optical path of optical signals generated by the brightfield light source 430 may propagate through the cartridge 410 and the objective lens 101 and to the imaging sensor 152. Accordingly, in embodiments, the imaging sensor 152 may, thereby, capture images of the cartridge 410.

As described above, in embodiments, the motor 140 may enable movement of the objective lens 101 (parallel to, for example, the z-axis of the coordinate planes of FIG. 4) relative to the microscopy body 110. Accordingly, in embodiments, the motor 140 may enable a user of the microscopy assembly 100 to reposition and/or focus the objective lens 101 relative to the cartridge 410 and/or the microscopy body 110.

Referring still to FIG. 4, in embodiments, precisely repositioning the objective lens 101 relative to the microscopy body 110 may include determining relative positions of the objective lens 101 relative to the microscopy body 110. Accordingly, in embodiments, the microscopy assembly 100 may include a distance sensor assembly 160. In embodiments, the distance sensor assembly 160 may include a sensor 162 and a sensing target 164. In embodiments, the sensor 162 is attached to the second mounting bracket 330 (on, for example, target flanges 334 of the second mounting bracket 330, as depicted in FIG. 3A), while the sensing target 164 is attached to the first mounting bracket 320. Accordingly, since, in embodiments, both the sensing target 164 and the objective lens 101 are attached to the first mounting bracket 320, the distance sensor assembly 160 may, in embodiments, be coupled to the objective lens 101.

In embodiments, the distance sensor assembly 160 may directly detect a detected distance 168 between the sensor 162 and the sensing target 164. The term “directly detects” as used herein includes detecting an actual distance between a first object (for example, the sensor 162) and a second object (for example, the sensing target 164). Accordingly, a device does not directly detect a detected distance if the detected distance is detected relative to an inputted reference position. Accordingly, since, in embodiments, the distance sensor assembly 160 directly detects the detected distance 168, in embodiments, the distance sensor assembly 160 may not require the input (by, for example, a user) of a reference position to detect the detected distance 168.

Since, in embodiments, the second mounting bracket 330 is fixed in position relative to the microscopy body 110 while the first mounting bracket 320 (to which, in embodiments, the objective lens 101 is attached) may move (via, for example, the motor 140), the detected distance 168 may be indicative of a position of the microscopy body 110 relative to the objective lens 101 (by, for example, pre-recording a distance between the sensing target 164 and the objective lens 101) and, thereby, of a distance between the objective lens 101 and the microscopy body 110. Accordingly, in embodiments, by detecting the detected distance 168, the distance sensor assembly 160 may enable the precise movement of the objective lens 101 relative to the microscopy body 110 by precisely determining relative positions of each. However, it should be understood that, while, in the embodiment of FIG. 4, the sensor 162 is fixed relative to the microscopy body 110 (by, for example, being positioned on the second mounting bracket 330) and the sensing target 164 is movable relative to the microscopy body 110 (by, for example, being positioned on the first mounting bracket 320), this orientation of the sensor 162 and the sensing target 164 is not mandatory for the function of the distance sensor assembly 160. Rather, in embodiments, the sensing target 164 may be fixed relative to the microscopy body 110 (by, for example, being positioned on the second mounting bracket 330) while the sensor 162 is movable relative to the microscopy body 110 (by, for example, being positioned on the first mounting bracket 320). Further, in embodiments (such as, for example, embodiments wherein the second mounting bracket 330 and the microscopy body 110 are monolithically formed), either the sensor 162 or the sensing target 164 may be attached to the microscopy body 110.

In embodiments, the sensor 162 may be an inductance sensor, comprising, for example, a wound coil (formed from, for example, copper) and the sensing target 164 may comprise a metallic target 166 (for example, a metal plate). Accordingly, in embodiments, an inductance measured by the sensor 162 may be a measure of the distance of the metallic target 166 from the sensor 162, as the inductance of the coil of the sensor 162 may vary as the position of the metallic target 166 varies relative to a position of the sensor 162. Accordingly, in embodiments, the sensor 162 may directly detect the detected distance 168 between the sensor 162 and the metallic target 166, as no reference input is necessary to calculate the inductance of the coil of the sensor 162. In embodiments, inductance of the sensor 162 may be measured by a circuit board of the distance sensor assembly 160. Accordingly, in embodiments wherein the sensor 162 is an inductance sensor, the sensor 162 may continually provide an electronic feedback signal to the circuit board of the distance sensor assembly 160 even if power to the distance sensor assembly 160 is halted or interrupted, as electricity may flow through the coil of the sensor 162 even in such circumstances.

In embodiments, measurements of the sensor 162 (for example, inductance measurements) may vary with a temperature of the sensor 162. Accordingly, in embodiments, the distance sensor assembly 160 may also include a temperature sensor 169 (for example, positioned on and/or electrically coupled to a circuit board of the distance sensor assembly 160) which may measure a temperature of at least part of the distance sensor assembly 160 (for example, a temperature of the coil of the sensor 162 and/or a temperature of the metallic target 166). By measuring a temperature of at least part of the distance sensor assembly 160, variances in measurements (for example, inductance) of the distance sensor assembly 160 due to variances in temperature of components of the distance sensor assembly 160 may be used in calculating the detected distance 168, thereby, in embodiments, reducing and/or eliminating uncertainty in the detected distance 168 due to temperature variations of the distance sensor assembly 160.

Referring again to FIG. 1, in embodiments, the light source assemblies 120A, 120B may include an aligned light source assembly 120A. Accordingly, in embodiments, the aligned light source assembly 120A may include an aligned light source 121A. In embodiments, the aligned light source 121A may be define an aligned light source axis 122A which, in embodiments, may be aligned with the light source optical axis 114. In embodiments, the light source assemblies 120A, 120B may also include a transverse light source assembly 120B. Accordingly, in embodiments, the transverse light source assembly 120B may include a transverse light source 121B. In embodiments, the transverse light source 121B may be define a transverse light source axis 122B which, in embodiments, may be transverse to the aligned light source axis 122A.

In embodiments, the aligned light source assembly 120A may include an aligned light source lens 123A, and, in embodiments, the aligned light source 121A may be optically aligned with the aligned light source lens 123A. That is to say, in embodiments, both the aligned light source 121A and the aligned light source lens 123A may both have radial centers along the aligned light source axis 122A such that, for example, the aligned light source 121A and the aligned light source lens 123A are optically coupled. Accordingly, in embodiments, the aligned light source 121A may emit optical signals through the aligned light source lens 123A and into the light source optical pathway 113. Accordingly, in embodiments, the aligned light source 121A may be optically coupled with the light source optical pathway 113.

In embodiments, the aligned light source assembly 120A may include an aligned light source lens housing 124A. In embodiments, and as described in further detail elsewhere herein, the aligned light source 121A may contact the aligned light source lens housing 124A to, for example, align the aligned light source 121A relative to the aligned light source axis 122A. In embodiments, the aligned light source 121A may directly contact the aligned light source lens housing 124A.

The term “directly contacts” as used herein to describe the position of a first component (for example, the aligned light source 121A) relative to a second component (for example, the aligned light source lens housing 124A) means that the first component contacts the second component without an intervening component positioned therebetween. Accordingly, in embodiments wherein the aligned light source 121A directly contacts the aligned light source lens housing 124A, there is no intervening component positioned between the aligned light source 121A and the aligned light source lens housing 124A.

In embodiments, the aligned light source assembly 120A may also include an aligned light source printed circuit board (“PCB”) assembly 125A, which may, in embodiments, be coupled (for example, electrically coupled) to the aligned light source 121A to, for example, provide power and instructions to the aligned light source 121A. In embodiments, the aligned light source assembly 120A may further include an aligned light source heat sink 126A, which may, in embodiments, absorb, diffuse, or otherwise transfer heat from the aligned light source PCB assembly 125A to the aligned light source heat sink 126A. In embodiments, the aligned light source PCB assembly 125A may be positioned between the aligned light source heat sink 126A and the aligned light source 121A.

In embodiments, the transverse light source assembly 120B may include a transverse light source lens 123B, and, in embodiments, the transverse light source 121B may be optically transverse with the transverse light source lens 123B. That is to say, in embodiments, both the transverse light source 121B and the transverse light source lens 123B may both have radial centers along the transverse light source axis 122B such that, for example, the transverse light source 121B and the transverse light source lens 123B are optically coupled. Accordingly, in embodiments, the transverse light source 121B may emit optical signals through the transverse light source lens 123B and into the first optical device 132A, which may, in embodiments, redirect optical signals from an optical path along the transverse light source axis 122B to an optical path along the light source optical axis 114. Accordingly, in embodiments, the transverse light source 121B may be optically coupled with the light source optical pathway 113.

In embodiments, the transverse light source assembly 120B may include a transverse light source lens housing 124B. In embodiments, and as described in further detail elsewhere herein, the transverse light source 121B may contact the transverse light source lens housing 124B to, for example, align the transverse light source 121B relative to the transverse light source axis 122B. In embodiments, the transverse light source 121B may directly contact the transverse light source lens housing 124B.

In embodiments, the transverse light source assembly 120B may also include a transverse light source PCB assembly 125B, which may, in embodiments, be coupled (for example, electrically coupled) to the transverse light source 121B to, for example, provide power and instructions to the transverse light source 121B. In embodiments, the transverse light source assembly 120B may further include a transverse light source heat sink 126B, which may, in embodiments, absorb, diffuse, or otherwise transfer heat from the transverse light source PCB assembly 125B to the transverse light source heat sink 126B. In embodiments, the transverse light source PCB assembly 125B may be positioned between the transverse light source heat sink 126B and the transverse light source 121B.

Referring now to FIGS. 1 and 2, in embodiments, the aligned light source assembly 120A may be attached to an aligned light source assembly mounting surface 220A of the microscopy body 110. In embodiments, the aligned light source assembly 120A may be attached to the aligned light source assembly mounting surface 220A by one or more aligned light source fasteners 127A, which may, in embodiments, clamp the aligned light source assembly 120A to the aligned light source assembly mounting surface 220A. Accordingly, in embodiments, the aligned light source 121A may be fixed to the microscopy body 110 and may thereby emit light into an aligned light source optical pathway 221A of the microscopy body 110 and, thereby, into the light source optical pathway 113.

In embodiments, the transverse light source assembly 120B may be attached to a transverse light source assembly mounting surface 220B of the microscopy body 110. In embodiments, the transverse light source assembly 120B may be attached to the transverse light source assembly mounting surface 220B by one or more transverse light source fasteners 127B, which may, in embodiments, clamp the transverse light source assembly 120B to the transverse light source assembly mounting surface 220B. Accordingly, in embodiments, the transverse light source 121B may be fixed to the microscopy body 110 and may thereby emit light into a transverse light source optical pathway 221B of the microscopy body 110 and, thereby, into the light source optical pathway 113.

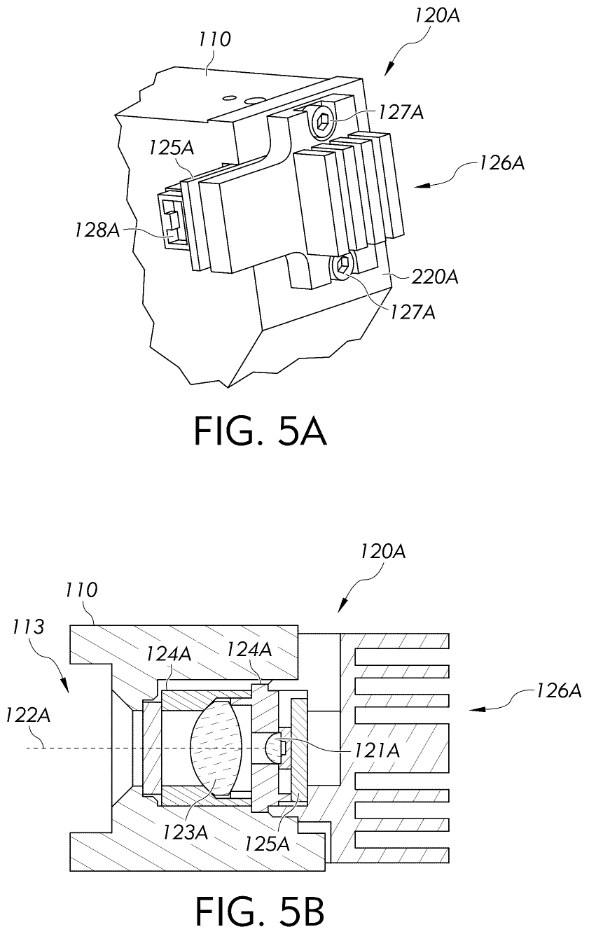

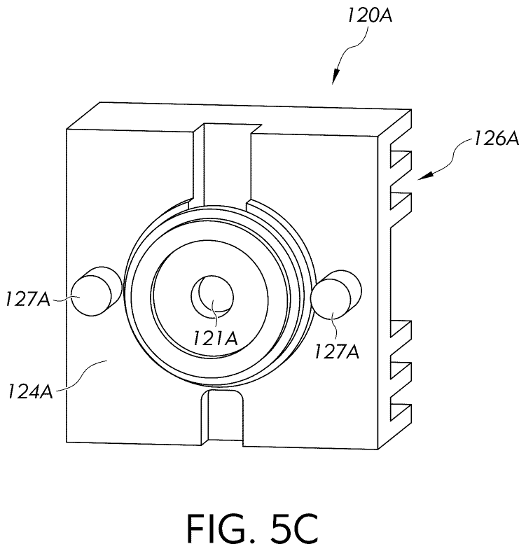

Referring to FIG. 5A, an external view of the aligned light source assembly 120A coupled to the microscopy body 110 are depicted. However, it should be understood that the description of the embodiments of the aligned light source assembly 120A depicted in FIGS. 5A-5C is not limited to exclusively the aligned light source assembly 120A and the components thereof. Rather, in the descriptions of FIGS. 5A-5C herein, the description of embodiments of the aligned light source assembly 120A, the components thereof, and relationships between the aligned light source assembly 120A (and components thereof) to the microscopy body 110 may also be understood to describe embodiments of the transverse light source assembly 120B, components thereof, and any other light source assemblies which may be included in embodiments of the microscopy assembly 100 and components thereof.

In embodiments, the aligned light source fasteners 127A may retain a position of the aligned light source assembly 120A relative to the microscopy body 110. In embodiments, the aligned light source PCB assembly 125A may receive electrical power and/or instructions via an electrical fiber inserted into a light source socket 128A, which may, in embodiments, enable the aligned light source 121A to both receive power and receive instructions to, for example, control any, some, or all of a brightness, color, wavelength, or other parameter of optical signals emitted by the aligned light source 121A.

Referring to FIGS. 5B-5C, in embodiments, the aligned light source 121A can be seen to directly contact the aligned light source lens housing 124A. In embodiments, the aligned light source lens housing 124A may be sized such that the aligned light source lens housing 124A may circumferentially contact the aligned light source 121A, thereby self-aligning the aligned light source 121A relative to other components of the microscopy assembly 100 such as, for example, either or both of the optical devices 132A, 132B and/or other optical devices of the microscopy assembly 100 that may be, for example, positioned within the microscopy body 110. Accordingly, in embodiments, the aligned light source assembly 120A may be readily insertable and/or removable into and/or from the microscopy body 110 (by, for example, inserting/removing the aligned light source fasteners 127A. Further, in embodiments, due to, for example, the direct contact of the aligned light source 121A with the aligned light source lens housing 124A, the aligned light source 121A may be aligned with, for example, optical devices of the microscopy assembly 100 (for example, either or both the optical devices 132A, 132B) upon attachment of the aligned light source assembly 120A to the microscopy body 110, without, in embodiments, requiring further alignment procedures of the aligned light source 121A by a user. Further, in embodiments, since the aligned light source fasteners 127A are removable, attachment of the aligned light source assembly 120A to the microscopy body 110 and/or alignment of the aligned light source 121A therein may not require post-alignment securing of the aligned light source 121A (as opposed to, for example, conventional light source assemblies which may require post-alignment securing of light sources by, for example, using fasteners or adhesives to secure such light sources after aligning such light sources). Accordingly, in embodiments, the self-alignment of the aligned light source 121A by the aligned light source lens housing 124A may reduce a time necessary to align the aligned light source 121A and/or may ease the assembly and/or disassembly of the aligned light source 121A. Further, the aligned light source fasteners 127A may, in embodiments, enable the aligned light source assembly 120A to be attached and/or detached from the microscopy body 110 without requiring destructive steps necessary with the same processes for conventional light source assemblies such as, for example, removing an adhesive attaching such conventional light source assemblies to conventional microscopy bodies.

It should now be understood that embodiments of the present disclosure relates to various microscopy assemblies which include an objective lens, one or more light sources, and a microscopy body. Particularly, embodiments of the present disclosure include microscopy assemblies having any, some, or all of a monolithic microscopy body, one or more modular inserts, a motor, and/or a distance sensor.

Further aspects of the embodiments herein are provided by the subject matter of the following clauses:

A microscopy assembly comprising: an objective lens defining an imaging path axis; one or more light sources; and a monolithic microscopy body, wherein: the monolithic microscopy body defines an objective optical pathway having an objective optical axis, the monolithic microscopy body defines a light source optical pathway having a light source optical axis, the light source optical axis is transverse to the objective optical axis, the objective lens is optically coupled to the objective optical pathway, each light source of the one or more light sources is optically coupled to the light source pathway, and the imaging path axis and the objective optical axis comprise a deviation of less than or equal to 0.2 degrees.

The microscopy assembly of any preceding clause, wherein the monolithic microscopy body defines a device cavity and the microscopy assembly further comprises a mirror positioned at least partially within the device cavity intersecting at least one of the objective optical axis and the light source optical axis.

The microscopy assembly of any preceding clause, further comprising a modular insert positioned at least partially within the device cavity, wherein the modular insert retains the mirror.

The microscopy assembly of any preceding clause, wherein the one or more light sources comprise an aligned light source defining an aligned light source axis and a transverse light source defining a transverse light source axis transverse to the aligned light source axis.

The microscopy assembly of any preceding clause, further comprising a light source lens, wherein at least one of the one or more light sources are optically aligned with the light source lens.

The microscopy assembly of any preceding clause, further comprising a lens housing, wherein at least one of the one or more light sources directly contacts the lens housing.

The microscopy assembly of any preceding clause, further comprising: a printed circuit board assembly coupled to at least one of the one or more light sources; and a heat sink, wherein the printed circuit board assembly is positioned between the heat sink and at least one of the one or more light sources.

The microscopy assembly of any preceding clause, further comprising an imaging sensor coupled to the microscopy body.

The microscopy assembly of any preceding clause, further comprising a brightfield light source positioned opposite the imaging sensor and optically coupled to the imaging sensor via the objective optical pathway.

The microscopy assembly of any preceding clause, further comprising a motor coupled to the objective lens, wherein the motor moves the objective lens with respect to the imaging sensor.

The microscopy assembly of any preceding clause, wherein the imaging sensor is positioned opposite the objective lens and is optically coupled to the objective lens via the objective optical pathway.

The microscopy assembly of any preceding clause, wherein at least one of the one or more light sources emit visible light, ultraviolet light, blue light, white light, fluorescence light, or any combination thereof.

The microscopy assembly of any preceding clause, further comprising a distance sensor coupled to the objective lens, wherein the distance sensor detects a distance indicative of a distance between the objective lens and the monolithic microscopy body.

A microscopy assembly comprising: an objective lens; one or more light sources; a microscopy body defining: an objective optical pathway defining an objective optical axis, a light source optical pathway defining a light source optical axis transverse to the objective optical axis, and a first optical device cavity; a modular insert engaged with the device cavity; and a mirror engaged with the modular insert and positioned within at least one of the objective optical pathway and the light source optical pathway, wherein: the objective lens is optically coupled to the objective optical pathway, and the at least one of the one or more light sources is optically coupled to the light source optical pathway.

The microscopy assembly of any preceding clause, wherein the modular insert defines one or more engagement portions that retain the mirror at least partially within the modular insert.

The microscopy assembly of any preceding clause, wherein the one or more engagement portions comprise a first engagement portion and a second engagement portion opposite the first engagement portion.

The microscopy assembly of any preceding clause, wherein: the device cavity is a first optical device cavity; the modular insert is a first modular insert; the mirror is a first optical device; and the microscopy assembly further comprises: ma second modular insert engaged with the microscopy body, and a second optical device engaged with the second modular insert.

The microscopy assembly of any preceding clause, wherein the first optical device is positioned at least partially within the objective optical pathway and the second optical device is positioned at least partially within the light source optical pathway.

The microscopy assembly of any preceding clause, wherein the one or more light sources comprise an aligned light source defining an aligned light source axis and a transverse light source defining a transverse light source axis transverse to the aligned light source axis.

The microscopy assembly of any preceding clause, further comprising a light source lens, wherein at least one of the one or more light sources are optically aligned with the light source lens.

The microscopy assembly of any preceding clause, further comprising a lens housing, wherein at least one of the one or more light sources directly contacts the lens housing.

The microscopy assembly of any preceding clause, further comprising:
a printed circuit board assembly coupled to at least one of the one or more light sources; and a heat sink, wherein the printed circuit board assembly is positioned between the heat sink and at least one of the one or more light sources.

The microscopy assembly of any preceding clause, wherein the microscopy body is monolithic.

The microscopy assembly of any preceding clause, further comprising an imaging sensor coupled to the microscopy body.

The microscopy assembly of any preceding clause, further comprising a brightfield light source positioned opposite the imaging sensor and optically coupled to the imaging sensor via the objective optical pathway.

The microscopy assembly of any preceding clause, further comprising a motor coupled to the objective lens, wherein the motor moves the objective lens with respect to the imaging sensor.

The microscopy assembly of any preceding clause, wherein the imaging sensor is positioned opposite the objective lens and is optically coupled to the objective lens via the objective optical pathway.

The microscopy assembly of any preceding clause, wherein at least one of the one or more light sources emit visible light, ultraviolet light, blue light, white light, fluorescence light, or any combination thereof.

The microscopy assembly of any preceding clause, further comprising a distance sensor coupled to the objective lens, wherein the distance sensor detects a distance indicative of a distance between the objective lens and the monolithic microscopy body.

A microscopy assembly comprising: an objective lens; one or more light sources; a microscopy body movably coupled to the objective lens, the microscopy body defining an objective optical pathway and a light source optical pathway; and a distance sensor assembly coupled to the objective lens, wherein: the objective lens is optically coupled to the objective optical pathway, at least one of the one or more light sources is optically coupled to the light source optical pathway, and the distance sensor assembly directly detects a detected distance indicative of a position of the microscopy body relative to the objective lens.

The microscopy assembly of any preceding clause, wherein the distance sensor assembly comprises an inductance sensor.

The microscopy assembly of any preceding clause, wherein: the distance sensor assembly comprises a sensor and a sensing target; the detected distance is a distance between the sensor and the sensing target; and the microscopy body is secured to one of the sensor or the sensing target.

The microscopy assembly of any preceding clause, further comprising a temperature sensor configured to measure a temperature of at least part of the distance sensor assembly.

The microscopy assembly of any preceding clause, wherein the one or more light sources comprise an aligned light source defining an aligned light source axis and a transverse light source defining a transverse light source axis transverse to the aligned light source axis.

The microscopy assembly of any preceding clause, further comprising a light source lens, wherein at least one of the one or more light sources are optically aligned with the light source lens.

The microscopy assembly of any preceding clause, further comprising a lens housing, wherein at least one of the one or more light sources directly contacts the lens housing.

The microscopy assembly of any preceding clause, further comprising: a printed circuit board assembly coupled to at least one of the one or more light sources; and a heat sink, wherein the printed circuit board assembly is positioned between the heat sink and at least one of the one or more light sources.

The microscopy assembly of any preceding clause, wherein the microscopy body is monolithic.

The microscopy assembly of any preceding clause, further comprising an imaging sensor coupled to the microscopy body.

The microscopy assembly of any preceding clause, further comprising a brightfield light source positioned opposite the imaging sensor and optically coupled to the imaging sensor via the objective optical pathway.

The microscopy assembly of any preceding clause, further comprising a motor coupled to the objective lens, wherein the motor moves the objective lens with respect to the imaging sensor.

The microscopy assembly of any preceding clause, wherein the imaging sensor is positioned opposite the objective lens and is optically coupled to the objective lens via the objective optical pathway.

The microscopy assembly of any preceding clause, wherein at least one of the one or more light sources emit visible light, ultraviolet light, blue light, white light, fluorescence light, or any combination thereof.

A microscopy assembly comprising: an objective lens; one or more light sources; a microscopy body defining an objective optical pathway and a light source optical pathway; and a motor coupled to the objective lens and threadedly engaged with the microscopy body, wherein: the objective lens is optically coupled to the light source optical pathway, and the motor moves the objective lens relative to the microscopy body.

The microscopy assembly of any preceding clause, wherein the motor is a stepper motor.

The microscopy assembly of any preceding clause, wherein the microscopy body defines a threaded hole and the stepper motor comprises a threaded shaft threadedly engaging the threaded hole.

The microscopy assembly of any preceding clause, further comprising a mounting bracket and a motor nut defining the threaded hole, wherein the motor nut is coupled to the mounting bracket.

The microscopy assembly of any preceding clause, further comprising a roller bearing mounted to a side of the microscopy body, wherein the mounting bracket is mounted to the roller bearing.

The microscopy assembly of any preceding clause, wherein the objective lens is positioned above the microscopy body.

The microscopy assembly of any preceding clause, wherein the motor comprises a housing and a shaft extending outwardly from the housing, and wherein the housing is positioned above the shaft.

The microscopy assembly of any preceding clause, wherein the one or more light sources comprise an aligned light source defining an aligned light source axis and a transverse light source defining a transverse light source axis transverse to the aligned light source axis.

The microscopy assembly of any preceding clause, further comprising a light source lens, wherein at least one of the one or more light sources are optically aligned with the light source lens.

The microscopy assembly of any preceding clause, further comprising a lens housing, wherein at least one of the one or more light sources directly contacts the lens housing.

The microscopy assembly of any preceding clause, further comprising: a printed circuit board assembly coupled to at least one of the one or more light sources; and a heat sink, wherein the printed circuit board assembly is positioned between the heat sink and at least one of the one or more light sources.

The microscopy assembly of any preceding clause, wherein the microscopy body is monolithic.

The microscopy assembly of any preceding clause, further comprising an imaging sensor coupled to the microscopy body.

The microscopy assembly of any preceding clause, further comprising a brightfield light source positioned opposite the imaging sensor and optically coupled to the imaging sensor via the objective optical pathway.

The microscopy assembly of any preceding clause, wherein the imaging sensor is positioned opposite the objective lens and is optically coupled to the objective lens via the objective optical pathway.

The microscopy assembly of any preceding clause, wherein at least one of the one or more light sources emit visible light, ultraviolet light, blue light, white light, fluorescence light, or any combination thereof light.

The microscopy assembly of any preceding clause, further comprising a distance sensor coupled to the objective lens, wherein the distance sensor detects a distance indicative of a distance between the objective lens and the monolithic microscopy body.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A microscopy assembly comprising:
an objective lens defining an imaging path axis;
one or more light sources; and
a monolithic microscopy body, wherein:
the monolithic microscopy body defines an objective optical pathway having an objective optical axis,
the monolithic microscopy body defines a light source optical pathway having a light source optical axis,
the light source optical axis is transverse to the objective optical axis,
the objective lens is optically coupled to the objective optical pathway,
each light source of the one or more light sources is optically coupled to the light source pathway, and
the imaging path axis and the objective optical axis comprise a deviation of less than or equal to 0.2 degrees.

2. The microscopy assembly of claim 1, wherein the monolithic microscopy body defines a device cavity and the microscopy assembly further comprises a mirror positioned at least partially within the device cavity intersecting at least one of the objective optical axis and the light source optical axis.

3. The microscopy assembly of claim 2, further comprising a modular insert positioned at least partially within the device cavity, wherein the modular insert retains the mirror.

4. The microscopy assembly of claim 1, wherein the one or more light sources comprise an aligned light source defining an aligned light source axis and a transverse light source defining a transverse light source axis transverse to the aligned light source axis.

5. The microscopy assembly of claim 1, further comprising a light source lens, wherein at least one of the one or more light sources are optically aligned with the light source lens.

6. The microscopy assembly of claim 5, further comprising a lens housing, wherein at least one of the one or more light sources directly contacts the lens housing.

7. The microscopy assembly of claim 1, further comprising:
a printed circuit board assembly coupled to at least one of the one or more light sources; and
a heat sink, wherein the printed circuit board assembly is positioned between the heat sink and at least one of the one or more light sources.

8. The microscopy assembly of claim 1, further comprising an imaging sensor coupled to the microscopy body.

9. The microscopy assembly of claim 8, further comprising a brightfield light source positioned opposite the imaging sensor and optically coupled to the imaging sensor via the objective optical pathway.

10. The microscopy assembly of claim 8, further comprising a motor coupled to the objective lens, wherein the motor moves the objective lens with respect to the imaging sensor.

11. The microscopy assembly of claim 8, wherein the imaging sensor is positioned opposite the objective lens and is optically coupled to the objective lens via the objective optical pathway.

12. The microscopy assembly of claim 1, wherein at least one of the one or more light sources emit visible light, ultraviolet light, blue light, white light, fluorescence light, or any combination thereof.

13. The microscopy assembly of claim 1, further comprising a distance sensor coupled to the objective lens, wherein the distance sensor detects a distance indicative of a distance between the objective lens and the monolithic microscopy body.

14. A microscopy assembly comprising:
an objective lens;
one or more light sources;
a microscopy body defining:
an objective optical pathway defining an objective optical axis,
a light source optical pathway defining a light source optical axis transverse to the objective optical axis, and
a first optical device cavity;
a modular insert engaged with the device cavity; and
a mirror engaged with the modular insert and positioned within at least one of the objective optical pathway and the light source optical pathway, wherein:
the objective lens is optically coupled to the objective optical pathway, and
the at least one of the one or more light sources is optically coupled to the light source optical pathway.

15. The microscopy assembly of claim 14, wherein the modular insert defines one or more engagement portions that retain the mirror at least partially within the modular insert.

16. The microscopy assembly of claim 15, wherein the one or more engagement portions comprise a first engagement portion and a second engagement portion opposite the first engagement portion.

17. The microscopy assembly of claim 16, wherein:
the device cavity is a first optical device cavity;
the modular insert is a first modular insert;
the mirror is a first optical device; and
the microscopy assembly further comprises:
a second modular insert engaged with the microscopy body, and
a second optical device engaged with the second modular insert.

18. The microscopy assembly of claim 17, wherein the first optical device is positioned at least partially within the objective optical pathway and the second optical device is positioned at least partially within the light source optical pathway.

19. The microscopy assembly of claim 14, wherein the one or more light sources comprise an aligned light source defining an aligned light source axis and a transverse light source defining a transverse light source axis transverse to the aligned light source axis.

20. The microscopy assembly of claim 14, further comprising a light source lens, wherein at least one of the one or more light sources are optically aligned with the light source lens.
